(19) United States
(12) Patent Application Publication
(10) Pub. No.: US 2015/0379089 A1
(43) Pub. Date: Dec. 31, 2015

(54) SEARCHING SYSTEM AND METHOD

(71) Applicant: Jagonal Pty Ltd, Sydney (AU)

(72) Inventor: Sergiy KOTLYAROV, Sydney (AU)

(21) Appl. No.: 14/754,709

(22) Filed: Jun. 30, 2015

(30) Foreign Application Priority Data
Jun. 30, 2014 (AU) 2014902513

(51) Int. Cl. G06F 17/30

(52) U.S. Cl. CPC G06F 17/30528; G06F 17/30867; G06F 17/30598; G06F 17/30477

(57) ABSTRACT

A method and system for providing enhanced searching and navigation, particular for classifieds websites. A server receives a search string from a client. The server determines keywords of the search string and references a keywords database to determine one or more keyword categories. A decision engine determines a navigation action of one of a plurality of navigation action types dependent on the keyword categories. The navigation action pertaining to the navigation action type can then be performed based on the keywords.

### CROSS REFERENCE TO RELATED APPLICATIONS

This application claims priority to Australian provisional patent application AU 2014902513, filed 30 Jun. 2014, the contents of which are herein incorporated by reference.

### FIELD OF THE INVENTION

This disclosure relates to systems and methods for conducting searches and in particular, though not exclusively, to search engines for conducting classifieds and database searches.

### BACKGROUND OF THE INVENTION

There are many different search engines that are used for performing internet and database searching. Internet search engines utilise a series of keywords with each word in the keyword string being considered. More recently, smart searches enable a user to enter their search query in a more grammatical manner, such as “what is the temperature of the sun?”. The search engine is designed to extract the keywords from such queries and would, for this example, ignore the words [what, is, the, of, the] and instead understand the keywords to be [temperature] and [sun]. The search engine would thus return pages relating to the temperature AND sun, with the pages ranked according to an appropriate page ranking methodology.

While free form search engines are easier to use and are generic for searching any type of text data, one problem with existing free form search engines is that it is often the content or website creator that creates the tags for the content. It is therefore in the creator's interests to manipulate the search engines to make their own content as visible as possible, often to the detriment of the search quality. Another problem is that it can be difficult to use descriptive terms because content creators will often use desirable descriptive terms, e.g. “quality”, “best”, “cheapest”, to boost the attractiveness of their content, which, when many creators use the same terms, can diminish the relevance of those descriptors.

Classifieds sites and many retail websites aim to increase the accuracy of searches by providing form fields and form searches. An example of a form field search system is shown in FIG. 2. The form 20 includes an address field 22 that enables the user to enter address text. In the example presented, the user is performing a property search and has specified an area of properties by city/suburb, state and post code in the address field 22 of the form 20. The form 20 also includes drop down fields allowing the user to directly specify property type 23, minimum number of beds 24, maximum number of beds 25, minimum price 26 and maximum price 27. An advantage of form fields is that they return more expected results and can be specialised for industry but they take longer for the user to populate the search and therefore reduce the ease of use of the interface. A further disadvantage is that if the user does not correctly identify the appropriate data for the fields and categories, some highly relevant search results may be omitted.

Some websites enable a mixture of free form and form field searching. In a mixed search interface, the initial interface will include a free form search bar that prompts the user to enter free form text on which the initial search is conducted. On an initial search results page, shown in FIG. 3, the user will be displayed the results of the free form search and then be given the option to narrow the categories by selecting items from form fields 31, 32, 33 corresponding to different categories. The initial search identifies the available categories and fields that may be selected. The advantages of the mixed search include that the initial free form search does not omit relevant search results if the user were to incorrectly identify the relevant categories. All categories that match the user's original query are displayed but the user can quickly filter the search results down to the categories of interest, in part based on the number of the search results that the user may want to view.

However, even the mixed search can provide inaccurate search results in many contexts. For example, a search at a particular time on the popular classifieds site eBay™ using the search terms “used laptop” yielded a search result of 6,493 matches, of which 49 were actually new laptops.

The search may be conducted alternatively by searching for “laptop” in the search bar and selecting only “used” in the new/used filter. Searching by this method, i.e. mixed searching, yields 8,789 results. That is, by using “used” as a keyword in the free text search, instead of providing it as a form filter in a mixed search, eBay is losing 2,345 relevant results and returns 49 irrelevant results.

Similarly, a search on the classifieds site Gumtree™ for “laptop from $200” yielded 221 records, many of which were not relevant. Searching for “laptop” and then using the “Price” form to filter all laptops “from $200” returns 2,403 absolutely relevant records. Thus, by treating the words “from” and “$200” as keywords in a free text search the Gumtree search application loses many otherwise relevant results.

These examples demonstrate that though some websites provide a mixed search interface, they are ill equipped to handle many plain speech or plain text search strings.

A further issue with some classifieds searching is that the classifieds may offer a variety of information types. For example, a property listings classifieds used for real estate transactions (buy, sell, rent, lease, etc.) may have pages of different types pertaining to, for example and without limitation, properties, buildings, real estate agent companies, specific real estate agents, etc. A user of the site may wish to visit any one of these page types, yet only a single search form is presented on the initial home page. To access these different types of pages, the user must first enter a search. The server will present the user with a list of search results which may include the user's desired page which the user can subsequently select to navigate to the desired page. The user therefore needs to perform multiple navigation steps to get to their end goal.

What is required is an improved search engine system and method.

### SUMMARY OF THE INVENTION

In one aspect, there is provided a method of performing a search. The method may include receiving a search string into a computer system, determining one or more keywords from the search string, determining one or more keyword categories pertaining to the determined one or more keywords, determining one or more navigation action types for the determined one or more keyword categories, and performing at least one navigation action for the determined one or more navigation action types in respect of the determined one or more keywords.

In one aspect, there is provided a system for providing information navigation, the system including a database of keyword categories, each keyword category including one or more keywords. At least one processor may be programmed to receive a search string, determine one or more keywords from the search string, determine one or more of the keyword categories pertaining to the determined one or more keywords, determine one or more navigation action types for the determined one or more keyword categories, and perform at least one navigation action for the determined one or more navigation action types in respect of the determined one or more keywords.

In one aspect, there is provided a method of performing a search. The method may include receiving a text search string into a computer system including at least one processor programmed to receive the text search string. The computer system may identify a plurality of keywords of the text search string and determine, by reference to a defined keyword hierarchy, a hierarchy for the plurality of keywords, the hierarchy including at least one first order keyword and at least one second or lower order keyword. The method may include creating, by the computer system, an interpreted search string including for at least one second or lower order keyword, interpreting, by the computer system, the respective keyword by reference to at least one higher order keyword. The computer system may execute a search query to at least one data source using the interpreted search string.

In one aspect, there is provided a computer system for implementing the above method.

### BRIEF DESCRIPTION OF THE DRAWINGS

Reference will now be made, by way of example only, to specific embodiments and to the accompanying drawings in which:

FIG. 1 depicts a computer system that may be used to implement one or more embodiments of the present invention;

FIG. 2 depicts an interface for a prior art form field search;

FIG. 3 depicts an interface for a prior art mixed search;

FIG. 4 depicts a client/server system;

FIG. 5 depicts an interface for a search methodology of an embodiment of the present invention;

FIG. 6 depicts an interpreted search string and initial search result;

FIG. 7 depicts a flowchart for interpreting a user entered search string into an interpreted search string;

FIG. 8 depicts a system for providing enhanced navigation using a search tool;

FIG. 9 depicts an interface for creating populating keyword categories; and

FIG. 10 depicts a system for providing third party search string interpretation.

### DETAILED DESCRIPTION OF THE INVENTION

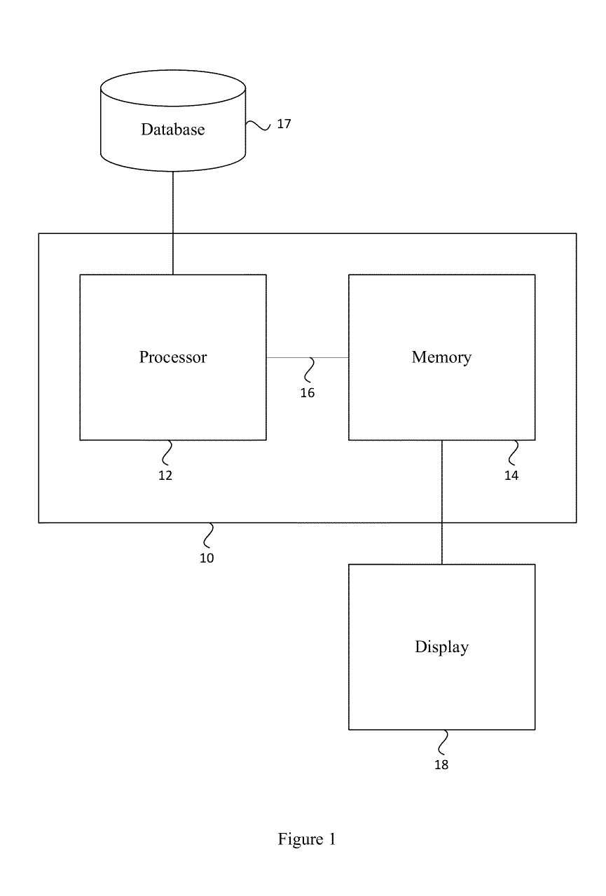

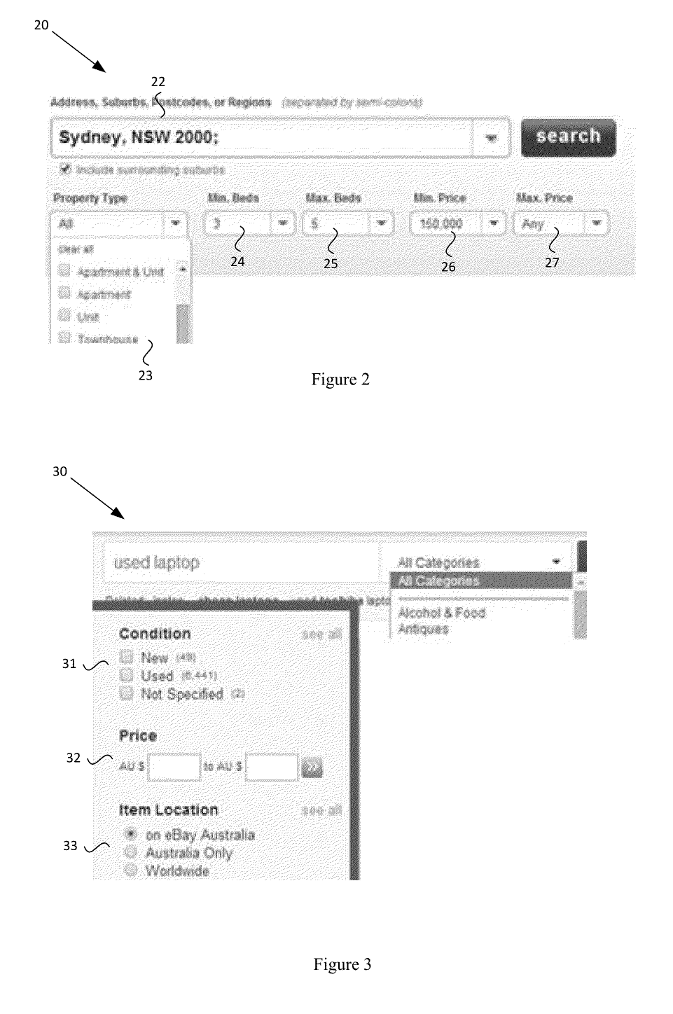

Methods in accordance with various embodiments of the present disclosure may be implemented on a computer system depicted generally in FIG. 1. The computer system 10 may include a processing unit 12 which may include one or more processors, which may be distributed or co-located. Processing unit 12 may be operatively associated with system memory 14, e.g. via a system bus 16. The system bus 16 may be any of several types of bus architectures including a memory bus, a memory controller, a peripheral bus, etc. The system memory 14 may include random access memory (RAM) and/or read only memory (ROM). The computer system 10 may further include one or more databases depicted singularly at 17 in FIG. 1. The database(s) may be singular or multiple and may be distributed as required. The particular configuration of the computer system 10, its components and architecture are not considered pertinent to the present disclosure and many forms of the computer system will be apparent to the person skilled in the art, with all such forms intended to be encompassed herein.

For example, the computer system 10 may be a single integrated device, such as a desktop computer, laptop, mobile device, etc. Alternatively, the computer system 14 may be a distributed system including multiple computers, i.e. multiple processors and memories and may include server and client devices. Components of the computer system 10 may communicate with each other and with other computer systems through any suitable means, including direct hardwired connections and/or through various wired or wireless communication networks such as internet, mobile networks, local area networks, etc. using any suitable known protocol, e.g. TCP/IP.

The computer system 10 may be operatively associated with one or more displays, shown singularly at 18 in FIG. 1, which may be any type of display suitable for displaying information to a user.

The system memory 14 may store application code that can be accessed and executed by the processing unit 12. Various embodiments of application code will be described hereinbelow.

The processing steps described herein, while described discretely, may be steps performed entirely within the memory of the computer system 10. The results of the individual steps described herein may be files or data that are stored for a time or may be data that only exists within the processing memory, such as within buffers or registers, until subsequent steps are performed. That is, the processing steps described herein may or may not have discrete outputs.

In one embodiment, there is provided a search method in which keywords entered into a free form search bar are interpreted as filters of the form search using an interface similar to a full text search, thereby improving relevancy of returned records on classifieds websites and the like.

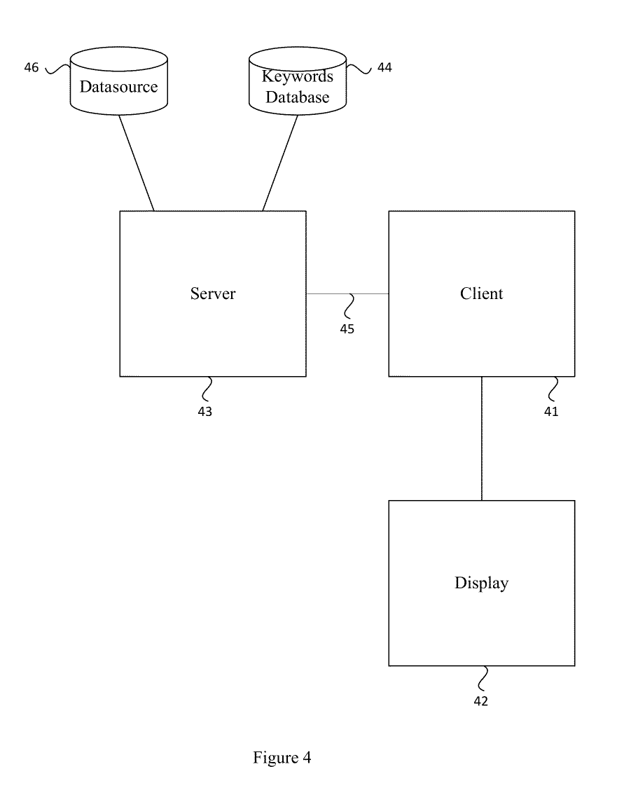

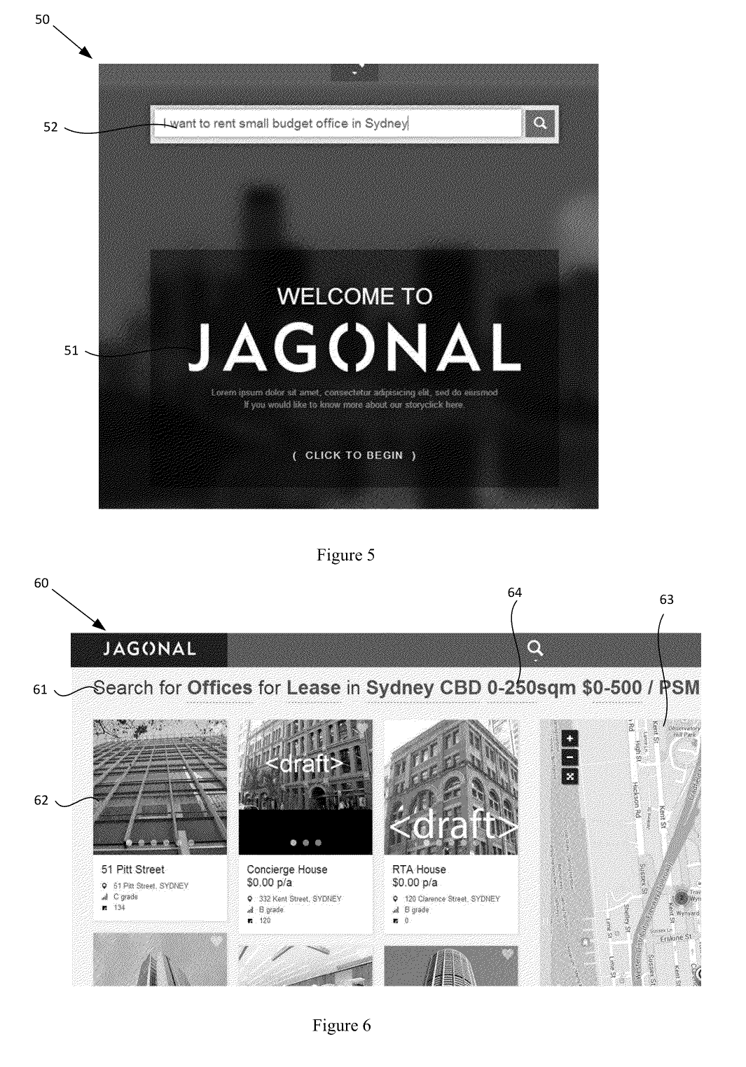

FIG. 4 shows an embodiment 40 of the computer system 10 of FIG. 1. The computer system 40 may include a client device 41 that displays a search application interface on a display 42 associated with the client device 41. The client device may be any suitable computing device including, without limitation, a fixed device, laptop, mobile device, etc. An example of the search application interface 50 is shown in FIG. 5. The interface 50 includes a first screen that provides a welcome message 51 and includes a search bar 52 that enables a user to enter a free form search string.

The search application interface executing on the client device 41 passes the entered search string to a server device 43 through a communications network 45, such as the internet, local area network, mobile data network, etc.

The server 43 receives the search string and maps the free form text to a plurality of form fields of a form search. The mapping may be performed with reference to a keywords database 44 that stores associations between keywords and respective form fields of a search form. Within the keywords database, there may be provided a list of form fields. Each form field may have a list of keywords that map to that form field.

Once the keywords have been mapped to the search form, a form search e.g. SQL search, as opposed to a free text search, may then be performed on a datasource 45 that contains searchable records. In one embodiment, the datasource 45 may be incorporated into the keywords database 44. The server 43 provides the search results to the client 41.

FIG. 6 shows an initial search result that is presented by the search application in response to the user's search string. The search result includes an interpreted search string 61 and a plurality of search results 62 that match the mapped form search. In the current example, the search is a property search and thus the search results page 60 includes a locality map 63 that may be used to display locations of the properties located by the search.

In the presently depicted embodiment, the user has entered the search string “I want to rent small budget office in Sydney”. The server 43 processes the free form search string to identify the searchable keywords. Searchable keywords are those words that have a matching entry in the keywords database. Search string words that are not present in the database are ignored. For the present example, the words [I], [want], [to] and [in] would not be considered searchable and are therefore eliminated from the search string. The remaining words, [rent], [small], [budget], [office] and [Sydney] are therefore the identified searchable keywords. These words can then be mapped to form fields for conducting an SQL or similar search. For example, the keyword [Sydney] may be mapped to an address field of the form, the keyword [office] may be mapped to a property type field, [budget] may be mapped to a price field, etc.

The form search created by the mapping process can be performed on the datasource 46 which, in the present example, would be a database of property listings.

By mapping the identifiable searchable keywords to form fields, the ease of use of a free form search bar is maintained, while maintaining the accuracy and relevancy of the form search methods.

To refer back to a previously described example, a search conducted by entering “used laptop” in the free form search bar of the search interface 50, would, using the presently described search method, result in the word “used” being identified as a searchable keyword and mapped to the “new/used” field of a search form. The search would identify all advertisements featuring the term “laptop”, and then filter the search to limit the results to only those results categorised as “used”, whether or not the term “used” appears in the text of the advertisement. As a result, a user may enjoy the simplicity of the Full Text Search and accuracy of the Form Search on a classifieds portal.

In one embodiment, the user entered search string may undergo interpretation as an alternative or as an addition to the field mapping process described above. The search results interface 60 of FIG. 6 shows an interpreted search string 61 being different to the user entered search string. In the present example, the user-entered search string “I want to rent small budget office in Sydney” has been interpreted as “Offices for lease in Sydney CBD 0-250sqm $0-$500 psm”. The interpreted search string is formulated into an SQL query that is passed to the relevant database that stores the records of property listings.

Interpretation of keywords allows greater consistency and relevancy of search results by placing the interpretation of certain terms in the hands of the system administrators, rather than the advertisement creators.

Words within a text input, e.g. search string may be interpreted based on the context provided by other words of the search string. For example, when a user enters the search string “Office in Sydney”, it is highly probably that the user intends the search to be limited to the Sydney CBD. That is, the term “Office” sets the context for defining what the user intends by “Sydney”. The search engine may thus interpret “Sydney” as meaning “Sydney CBD” when in the context of the term “office” and proceed to limit the search results to Sydney CBD offices. On the other hand, when a user enters the search terms “Warehouse in Sydney”, the user is unlikely to want to limit the search to the Sydney CBD and thus a different interpretation of “Sydney” for the “Warehouse” context may be more appropriate.

In another example, the terms “cheap”, “budget” and the like will have different meanings in different contexts. “Cheap” office space in Sydney may indicate a price range of $0-$500 per m² whereas “cheap” office space in Sydney suburban areas might indicate a price range of $0-$350 and “cheap” office space in Brisbane CBD might have a price range of $0-$400. A completely different set of price ranges may apply if the search is conducted for warehouse space. That is a hierarchy may be defined as follows:

[Property Type]→[Location]→[Price]

The interpretation of the lowest order term, i.e. [Price] may be modified firstly by the [Property Type], i.e. Office or Warehouse, and then by the [Location], i.e. Sydney CBD, Sydney Suburban or Brisbane CBD.

Another parameter that is open to interpretation are size indicating parameters. “Small Office” will be a different consideration to “Small warehouse”.

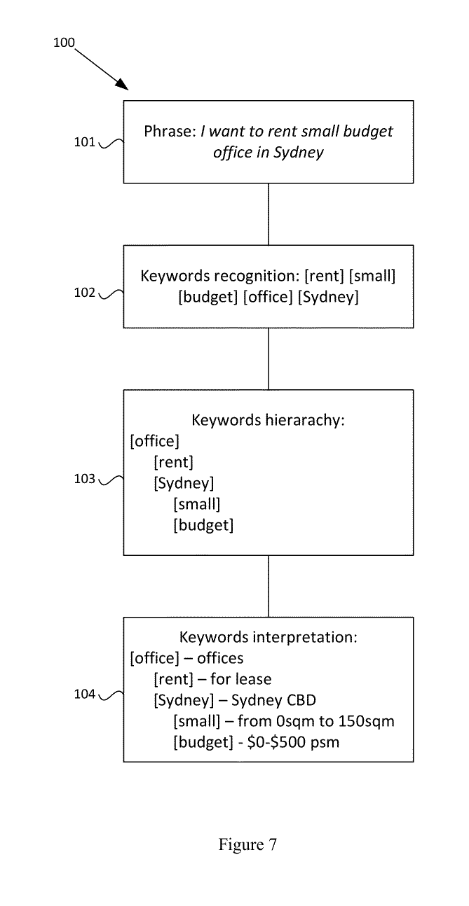

The interpretation of the search string may follow a process that will be described with reference to the flowchart 100 of FIG. 7. At step 101, the user entered search string is passed from the client device to the server device. At step 102, the server device, having received the search string, performs a keyword recognition process by comparing the words of the search string to a keyword database, e.g. database 44. The keyword recognition process determines what words are relevant to the search and eliminates those words that are not relevant. In the current example, the keyword recognition process transforms, at step 102, the search to its searchable keywords [rent], [small], [budget], [office], [Sydney] by eliminating the words [I], [want to] and [in].

At step 103, further reference is made to the keyword database, or an additional database, to determine a hierarchy of the identified keywords. In the example, [office] has the highest order, [rent] and [Sydney] are 2^{nd} order keywords and [small] and [budget] are the lowest order keywords. The hierarchy may be preformulated in the keyword database by the system operator. In one embodiment, the hierarchy may be determined by a hierarchy of the fields of the form search process described above.

At step 104, further reference is made to the keyword database, or an additional database, to interpret the keywords according to the hierarchical structure. The word [Office], being the highest order keyword, is interpreted only according to any interpretations for the word Office in the keyword database. In the present case, [office] has no substantial interpretation. In an alternative, if the user had entered “workplace”, the term might have been interpreted as “office” if this synonym was listed in the keyword database in association with “workplace”.

The next word in the hierarchy is the second order word [rent]. The search application interprets the word [rent] by reference to any synonyms listed for the word [rent] AND, being a second order word, any interpretations listed for the higher order word [office]. In the present example, [rent] is associated with the synonym [for lease].

The next word in the hierarchy is the second order word [Sydney]. The search application interprets the word [Sydney] by reference to both the word [Sydney] and the higher order word [Office]. In the current example, a rule has been set in the keyword database that any searches for Offices in Sydney will initially be conducted on the Central Business District (CBD). Thus, by referencing the higher order word Office, the term [Sydney] is interpreted as [Sydney CBD].

The rule may be set specifically for the city Sydney, or may be set for major cities, or may be set for any location such that the location is interpreted as the CBD of the location whenever an Office search is conducted

The next word in the hierarchy is the third order word [small]. Whether or not the property listing is classified as small will typically depend on the type of property, e.g. office, warehouse, etc as well as the location of the property, e.g. CBD, suburban, major city, rural town, etc. Thus, the third order keyword [small] is interpreted by reference to both the second order keyword [Sydney] and the first order keyword [Office]. In the present example, reference to the keyword database using the higher order keywords returns an interpretation of [small] as being the range 0-150 square meters (sqm).

The next word in the hierarchy is the third order word [budget]. Like the descriptive keyword [small], the descriptive word [budget] will have a range of interpretations based on context. The context may be determined from the higher order keywords, in this case [Sydney] and [Office]. In the present example, reference to the keyword database using the higher order keywords returns an interpretation of [budget] as being the range $0-500 per square meter (psm).

The result of the interpretation process is that the search string “I want to rent small budget office in Sydney” has been interpreted as “Offices for lease in Sydney CBD 0-250sqm $0-$500 psm”. This modified or interpreted search string is displayed on the interface page 60 in the search bar 61 as well as being used as the basis for the initial search. The search bar 61 is essentially a list of field codes and each of the individual fields 64 shown in the interpreted search bar 61 may be presented as a selectable menu, slidebar, etc. that enables the user to modify the individual search terms if the user disagrees with the interpretation or otherwise desires to modify the search parameters. Selecting “Sydney CBD” for example, may display alternatives such as “Sydney Metropolitan”, “Sydney North”, “Sydney South” etc, one or more of which may be selected to add to the search. Selecting 0-250sqm may display a slidebar with both of the end ranges being variable to set the range of office sizes to the search limits desired by the user. Modifying any of the search parameters may cause a new search to be conducted.

The interpretation process described with reference to FIG. 7 may be performed in isolation to or in conjunction with the field mapping process described above. When performed in conjunction with the field mapping process, the interpretation of the keywords may be made with reference to the respective field codes to which the keywords are mapped. For example, a “price” field may have several keywords mapped to it, including, without limitation, “cheap”, “budget”, “affordable”, and anything with a dollar sign “$”. Any of these keywords provided in the user-entered search string will be mapped to the price field of the search form. The price field have a number of interpretation rules such as: so that each of the words “cheap”, “budget”, “affordable” may be interpreted as a range of price values depending on the higher order keywords. Example interpretation rules may be as follows:

[price]:“cheap”, “budget”, “affordable”→$0-$500 WHEN [Office] AND [Sydney CBD]

[price]: “cheap”, “budget”, “affordable”→$0-$400 WHEN [Office] AND [Brisbane CBD].

In one embodiment, the keywords uniquely map to the field codes, that is, a keyword may appear in one and only one field code keyword list. In an alternative embodiment, a keyword may be present in more than one field code keyword list with its interpretation being dependent on different parent keywords in a keyword hierarchy of a search string. E.g., “cafe” can be a property type (“I want to buy a cafe”), and also an internal amenity (“I want to buy an office in a building with café on site”. Thus, in the second example, the presence of the term “office” in the search string sets the property type to “office” so that the word “café” is searched for in other field codes and then matched to the “internal amenity” field code. System rules may be provided so that the word “office” is treated as higher priority than “café” when setting the property type. Other examples of priority setting will be apparent to the person skilled in the art.

The search methodology is most suitable to structured searches, such as classifieds, retail websites, or similar database searches where the search terms are more consistent and known, as compared to open web page searches such as internet searches. However, the search methodology may be applied to web page searches where appropriate.

The keyword database 44 and its various keyword hierarchies and contextual interpretations may be populated by a system administrator or the like and revised as appropriate based on search histories and user statistics. For example, if it was recorded that users searching for “small offices in Sydney” routinely changed the predefined interpretation of [small] from “0-150sqm” to “0-175sqm”, then the user statistics may be used to edit this interpretation in the keyword database. The requirement to change the interpretation may be detected by periodically monitoring the user statistics and search histories. Alternatively or in addition, the computer system 10 on which the search methodology is implemented may incorporate a learning engine that is able to automatically detect when change to a keyword interpretation is required.

The search methodology described herein enables users to use descriptive words such as used, small, budget, etc. and have these words treated as form entries, leading to improved search results. In addition, these terms may have context dependent interpretations pre-stored in the system databases. Because the interpretations and definitions are prestored, the user is not relying on advertiser provided interpretations and thus the search results are more likely to be relevant to the user's search as well as having greater consistency of interpretation across the search results.

In addition to the form field mapping described above, the keywords database may be utilized to provide enhanced website navigation. An embodiment of a website navigation system is depicted in FIG. 7. Initially, the client 71 operating a browser will land on a home page or similar of a website administered and/or served by the server 73. The home page may be similar to the page 50 of FIG. 5, including a free form search bar 52.

The user enters free form text of one or more words, letters, numbers or symbols and selects the search button, causing the entered search string 72 to be sent to the server 73. The server 73 receives the search string and parses the search string to extract the keywords. The parsing process may take account of known search string methodologies. One methodology is extension in which a keyword is extended to include other common suffixes, prefixes, plurals, spelling alternatives, etc. Another methodology is grouping of keywords in which a search string such as MLC Center Sydney is parsed to form multiple keywords based on grouping. A highest priority keyword would be the full group “MLC Center Sydney”. The next highest priority would be the two word groups “MLC Center” and “Center Sydney” while the lower priority keywords would be the single word groups “MLC”, “Center” and “Sydney”.

A decision engine 75 is a software module that executes on one or more processors of the server 73 to analyze the keywords and determine a navigation action to be undertaken.

The decision engine 75 may make reference to the keywords database 77. The keywords database may include keywords that are organized into categories. The categories may have a hierarchical structure or a free-form structure. Categories may have sub-categories and/or parent categories. The decision engine 75 also makes reference to a rules database 79 that may associate navigation action types with keyword categories as well as other contextual information such as user ID, current webpage, etc. While the keywords database 77 and rules database 79 are shown as distinct entities, they may be combined.

From the keywords, the determined keyword categories and the rules database, the decision engine is able to determine one or more navigation actions to be performed. Navigation actions may include, without limitation, a direct navigation to a specific relevant webpage, a form search on the datasource 78 and return of a list of search results, a non-browser instruction e.g. send email. The navigation instruction 76 is sent to the client for display and/or action by the client.

The specific navigation action types and keyword categories will depend on the type of website provided by the server 73. In the following examples, specific reference will be made to a properties listing website for real estate, though this is intended as a non-limiting example only and a person skilled in the art will readily recognize that variations to the specific details provided are possible.

A typical search engine is only able to perform a single navigation action in response to a search string, that action being to search an index or database and return a list of search results that matches the search terms. Within a classifieds website, such as eBay™, the response will be a URL corresponding to the search terms. For example, if the user enters “used laptop”, the eBay server returns the URL: http://www.ebay.com.au/sch/i.html?_from=R40&_nkw=used+laptop

If a form search is submitted, the URL may include keywords mapped to form fields, such as “condition=used”. The URL presented to the user is displayed in the user's browser. The content for the URL may be generated dynamically by searching the eBay database for entries matching the search terms. However, the return of the URL is the only navigation action that the eBay server can perform when a user enters the search terms.

The decision engine 75 of FIG. 7 is able to provide enhanced website navigation, including performing different types of navigation actions that are dependent on the category of the keywords detected.

A first navigation action type may be to navigate to a specific relevant page, such as a company page. Categories associated with this navigation action type may include, without limitation, agent name, building name, company name. For example, when a user enters “Fred Smith, ABC Agency”, the server 73 will locate Fred Smith in the Agent Name category and ABC Agency in the Agent Company category. A rule in the rules database 79 may specify that where an Agent Name is found, the specific agent's profile is to be displayed. The server thus returns a URL corresponding to the specific agent. If the agency name is found but the agent name is not found, i.e. there is no “Fred Smith” associated with ABC Agency, the decision engine may apply a rule to return a URL for the Agency.

Similarly, if a user is searching for information on a specific building, they may search on that building name. If the building name is found, the server may return a webpage for that building.

A second navigation action type is to populate form fields. Such an action might be performed if keywords are determined to be in categories for, without limitation, suburbs; localities (e.g. CBD, outer west, etc.); landmarks (e.g. town hall, central station, Pitt Street Mall); amenities, grades and features (e.g. secure access, showers, cafes, childcare, A-grade buildings); and ranges. Ranges are not keywords, but rather regular expressions identifying a quantitative request (e.g. “Office up to $400/sqm”, “Office for 15 people”, “office for a budget $20,000 per year”). The presence of these categories is an indicator that the user is attempting a search of available properties, and the determined navigation action is therefore to conduct a form search using the form field mapping techniques described above.

A third navigation action type may be to perform an action other than to return a URL. For example, a user may enter a command string, such as “email Company X”, in which case the decision engine may proceed to instruct the user's email tool on the client 71 to create an email with the addressee field pre-populated with the email address of Company X.

Once the navigation action has been determined, the navigation action can be performed, with reference to the datasource 78 if required. For example, if the navigation action is to display an Agency webpage, the webpage may be generated dynamically using updated data from the datasource. Alternatively, if the navigation action is to provide a form based search, the form fields are mapped with the keywords, or interpreted versions thereof, and a form search is conducted on the datasource 78 to retrieve the relevant search results for display to the client under the appropriate search URL.

The keyword categories may include one or more categories for keywords that modify other categories. Such categories may be termed “Static” categories. For example, an Agency name might directly return the webpage for that Agency, whereas the Agency name plus the word “listings” is clearly a request for property listings by that Agency. Thus, the presence of the word “listings” modifies the action from a direct navigation action to a form search action.

Within this category, there may also be entries for keywords that modify other keywords, as has been described above. For example, descriptive words such as “small”, “budget” etc. may be interpreted into numeric ranges.

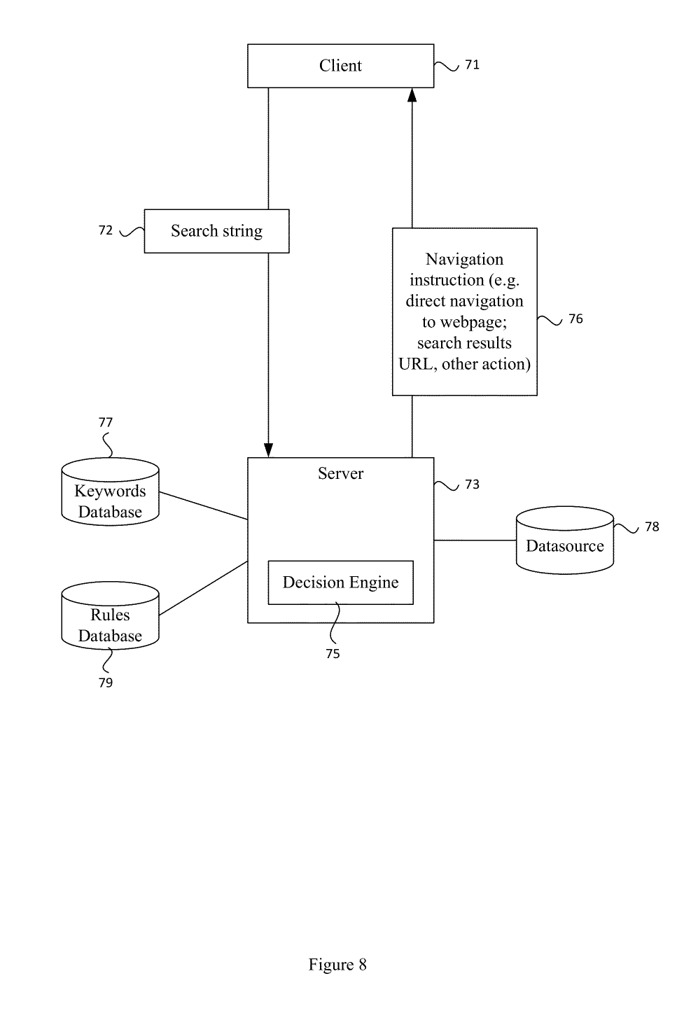

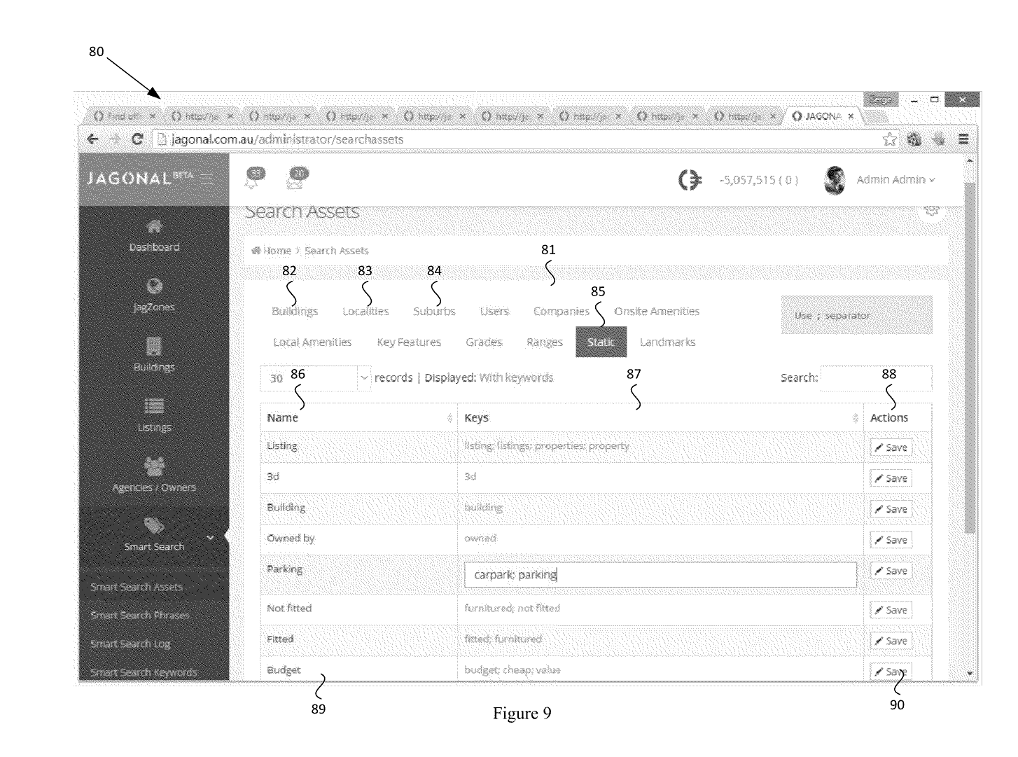

The keyword categories may be manually populated. An interface for populating the keyword categories is shown in FIG. 8. The interface 80 shows multiple categories 81, including Buildings 82, Localities, 83, Suburbs 84. In the example depicted, the “Static” category 85 is highlighted and is currently being populated on the interface 80. Within the static category, are subcategories identified by name 86. The subcategory has one or more keywords 87 that may be manually entered. The interface 80 includes a column 88 for defining rules or actions to be performed on this category. For example, for the budget subcategory 89, the words “budget”, “cheap” and “value” are entered as keywords. An action may be entered for this subcategory by selecting the corresponding action icon 90. The action may be to interpret the term to a price range according to the rule:

If (Locality=“CBD”) then price=$0-$500,000;

else price=$0-$300,000.

Such a rule is a relatively simple example. A more complex example may take account of additional parameters and keyword categories such as property type, property size, etc.

The rules database may treat the keyword categories as a hierarchy. For example, the Sydney CBD has a building named the MLC Center. There are many such examples throughout the major cities of the world, such as the Chrysler Building of New York, BT Tower in London, etc. The keyword “MLC” could therefore appear in both the Buildings category and the Companies category. A search for MLC Center could therefore return associations for both the Buildings category for the keyword “MLC Center” and for the Companies category for the keyword “MLC”. In this example, the user having entered “MLC Center” as a search term is more likely to be interested in properties in or around the MLC Center building rather than being interested in the MLC company. The rules database may therefore specify a rule that the Buildings category is to take precedence and thus perform a navigation action that is associated with the Buildings category, e.g. to navigate to a page pertaining to the building MLC Center which might display available properties within the MLC Center building. Alternatively, a search for “MLC” in the absence of the word “Center” could return a list of search results that includes a first link to the MLC Center building listings and a second link to the MLC Company web page.

For search efficiency, the categories may be treated as a hierarchy so that if a keyword is located in a highest category, the search may be stopped and a navigation action associated with the category can be performed.

Rules may specify various logical structure. With reference again to the MLC Center example, a search for “MLC Sydney CBD” is likely to be a search for the webpage pertaining to the MLC Center building, rather than the MLC Company. Thus, the presence of the locality category “Sydney CBD” and a partial match to a building name “MLC” may have a rule to treat the search as a building name or property search, rather than a company search. Thus, a rule may specify different actions dependent on the number or type of categories determined to be associated with the keyword(s).

The decision engine 75 may take account of factors other than the keywords. In one embodiment, the current page from which the search was submitted may provide context to the decision engine.

The system of FIG. 7 is shown and described with regard to text based entry of search terms on the client device but is particularly suitable for voice based navigation enhancement. The client browser 71 may be coupled with a voice to text interpreter, in particular where the client browser is executing on a mobile device or for access impaired users. Navigation instructions may be spoken and interpreted as text for submission as a search string. The voice to text conversion may be performed by the client or by the server.

Particular embodiments may include the ability to speak the name of a hyperlink, such as for email, Facebook™, or a hyperlinked document identified by words etc. and for the decision engine to determine the navigation action to be performed, such as opening a Facebook page of a particular entity.

The current webpage from which the search string was submitted may provide relevant context for such functions. For example, the search term “Facebook” from a Company webpage may direct the user to the Company's Facebook page whereas the search term “Facebook” from the generic homepage may open the user's own Facebook page.

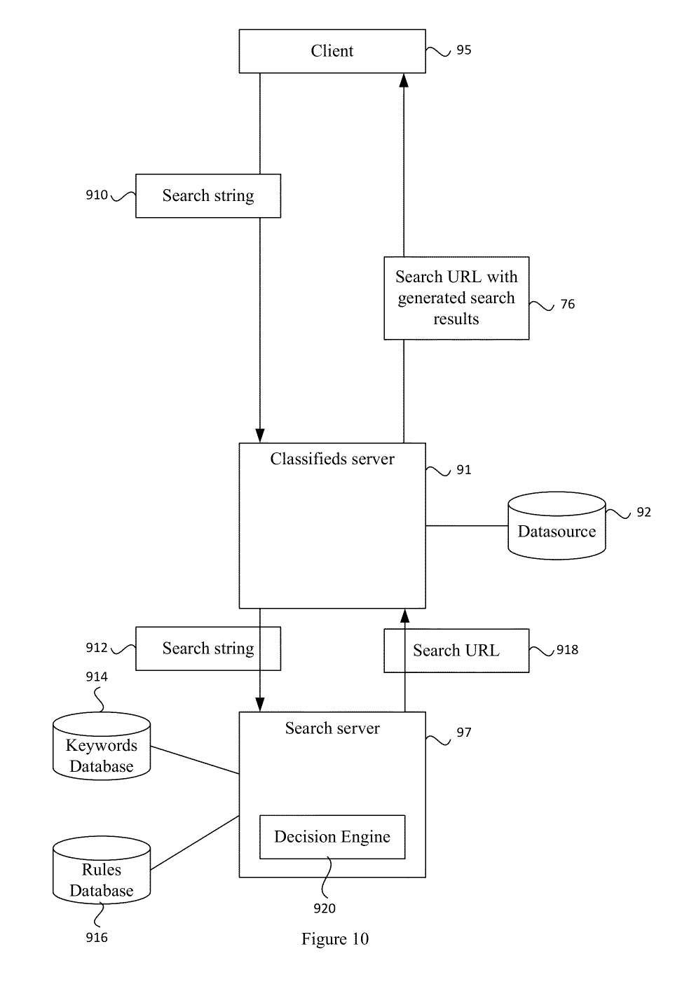

In one embodiment, the enhanced search string interpretation may be offered as a third party service via an appropriate API. By way of example and with reference to FIG. 10, a classifieds server 91, such as eBay™, having its own datasource 92 of classifieds listings may receive a search string 910 from a user 95 operating a client browser. The classifieds site would ordinarily create a URL reflecting the search terms, e.g. the “used laptop” example discussed above which may lead to the loss of search results and the inclusion of erroneous search results. The server would generate the content for the URL by conducting a keyword search on their datasource. In the present embodiment, the server 91 could pass the search string 912 to a second server 97 that offers the search string interpretation. The second server 97 could interpret the search string via a decision engine 920 with reference to the keywords database 914 and/or rules database 916, to map the search terms to form fields, with interpretation of any keywords as required, e.g. based on a determined keyword hierarchy. The second server 97 could return a URL 918 to the server 91 which reflects the fields and values. These fields and values are then used by the server 91 as a form search on its database to generate and return a more accurate search result to the client. The interpretation server 97 is able to generate the URL without access to the classifieds server's datasource because it only needs to determine the navigation action. The content to match the search URL can be generated by the Classifieds server 91 as normal, but with the enhanced search result. The URL and generated search results can then be returned to the client 95 by the classifieds server 91.

In a specific example, the server 91 may submit “used laptop” as a search string. Ordinarily, the ebay website would return the URL http://www.ebay.com.au/sch/i.html?_from=R40&_nkw=used+laptop which reflects that “used” and “laptop” are considered as keywords, leading to the erroneous results discussed above. By submitting the search string to the interpretation server 97, the string can be interpreted to a more appropriate URL http://www.ebay.com.au/sch/i.html?_from=R40&_nkw=laptop&LH_ItemCondition=4

The interpreter API would process the text “used laptop”, identify a keyword “used” and replace it with a URL parameter &LH_ItemCondition=4 which defines the “used” item condition on the ebay domain. This method can be used with a voice navigated app for ebay, Amazon and virtually any other website. It can be a web-browser powered by an API, which lets the user voice-control pages traditionally designed for navigation by clicks and taps, though clicks, taps and text entries will still apply.

In the embodiment of FIG. 10 the interpretation service is provided to the classifieds server. In an alternative embodiment, the search string interpretation may be provided directly to the user. An application on the user's device may detect when particular websites are being navigated and submit entered search strings, either spoken or typed, to the interpretation service. The interpretation service can provide an interpreted search string that is dependent on the site, the user or other parameters in a similar manner to discussed above.

While specific reference has been made to property listing searches, the search methodology is equally applicable to other search types and is particularly suitable for classifieds searching of virtually any product or service type. Thus, the database that is searched using the search methodology may store records of a wide variety of product or service types. Similarly, the database of keywords and the associated hierarchy may store keywords pertaining to the same variety of product and service types.

The term “keyword” is used herein for succinctness and clarity. However, the term “keyword” is not to be limited in its interpretation herein to single words and the person skilled in the art will readily understand that various phrases made up of multiple words may also be considered to be keywords. In the property industry, the term “for lease” may be considered a keyword. In the motor vehicle sector, the phrase “four wheel drive” may be considered a keyword. Other examples will be readily apparent.

Although embodiments of the present invention have been illustrated in the accompanied drawings and described in the foregoing description, it will be understood that the invention is not limited to the embodiments disclosed, but is capable of numerous rearrangements, modifications, and substitutions without departing from the spirit of the invention as set forth and defined by the following claims. For example, the capabilities of the invention can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current invention. Still further, although depicted in a particular manner, a greater or lesser number of modules and connections can be utilized with the present invention in order to accomplish the present invention, to provide additional known features to the present invention, and/or to make the present invention more efficient. Also, the information sent between various modules can be sent between the modules via at least one of a data network, the Internet, an Internet Protocol network, a wireless source, and a wired source and via plurality of protocols.

What is claimed is:

1. A system for providing information navigation via a browser, the system including:
(A) a database of keyword categories, each keyword category including one or more keywords;
(B) at least one processor programmed to:
(a) receive a search string;
(b) determine one or more keywords from the search string;
(c) determine one or more of the keyword categories pertaining to the determined one or more keywords;
(d) determine one or more navigation action types for the determined one or more keyword categories;
(e) perform at least one navigation action for the determined one or more navigation action types in respect of the determined one or more keywords.

2. The system of claim 1 including a rules database that associates at least one navigation action with at least one keyword category.

3. The system of claim 1 wherein the processor is programmed to determine the navigation action depending on the determined one or more keyword categories.

4. The system of claim 3 wherein at least one navigation action is dependent on a plurality of keyword categories.

5. The system of claim 1 wherein the processor is programmed to determine a hierarchy of the determined one or more keyword categories and to determine the at least one navigation action from the hierarchy.

6. The system of claim 1 wherein the at least one navigation action is dependent on a webpage from which the search string was submitted.

7. The system of claim 1 wherein the at least one processor is programmed to:
(A) determine by reference to a defined keyword hierarchy, a hierarchy for the one or more keywords, the hierarchy including at least one first order keyword and at least one second or lower order keyword;
(B) create an interpreted search string including for at least one second or lower order keyword, interpreting, by the computer system, the respective keyword by reference to at least one higher order keyword; and
(C) execute a search query to at least one data source using the interpreted search string.

8. A method of performing a search including:
(A) receiving a search string into a computer system;
(B) determining one or more keywords from the search string;
(C) determining one or more keyword categories pertaining to the determined one or more keywords;
(D) determining one or more navigation action types for the determined one or more keyword categories;
(E) performing at least one navigation action for the determined one or more navigation action types in respect of the determined one or more keywords.

9. The method of claim 8 including:
(A) determining by reference to a defined keyword hierarchy, a hierarchy for the one or more keywords, the hierarchy including at least one first order keyword and at least one second or lower order keyword;
(B) creating an interpreted search string including for at least one second or lower order keyword, interpreting, by the computer system, the respective keyword by reference to at least one higher order keyword; and
(C) executing a search query to at least one data source using the interpreted search string.

10. The method of claim 8 wherein receiving the search string includes receiving the search string from a classifieds server and wherein performing at least one navigation action includes generating a search URL for the classifieds server for execution by the classifieds server on a datasource of the classifieds server and returning the search URL to the classifieds server, the search URL including a mapping of one or more keywords of the search string to one or more form fields.

11. The method of claim 8 including determining the navigation action depending on the determined one or more keyword categories.

12. The method of claim 11 including determining the at least one navigation action from a plurality of keyword categories.

13. The method of claim 8 including determining a hierarchy of the determined one or more keyword categories and determining the at least one navigation action from the hierarchy.

14. The method of claim 8 including determining the at least one navigation action from a webpage from which the search string was submitted.

15. A method of performing a search including:
(A) receiving a text search string into a computer system including at least one processor programmed to receive the text search string;
(B) identifying by the computer system a plurality of keywords of the text search string;
(C) determining by reference to a defined keyword hierarchy, a hierarchy for the plurality of keywords, the hierarchy including at least one first order keyword and at least one second or lower order keyword;
(D) creating an interpreted search string including for at least one second or lower order keyword, interpreting, by the computer system, the respective keyword by reference to at least one higher order keyword; and
(E) executing a search query to at least one data source using the interpreted search string.

16. The method of claim 15 wherein receiving the search string includes receiving the search string from a classifieds server and wherein performing at least one navigation action includes generating a search URL for the classifieds server for execution by the classifieds server on a datasource of the classifieds server and returning the search URL to the classifieds server, the search URL including a mapping of one or more keywords of the search string to one or more form fields.

17. A computer system for performing a search of a database including at least one processor programmed to:
(A) receive a text search string;
(B) identify a plurality of keywords of the text search string;
(C) determine by reference to a defined keyword hierarchy, a hierarchy for the plurality of keywords, the hierarchy including at least one first order keyword and at least one second or lower order keyword;
(D) create an interpreted search string including for at least one second or lower order keyword, interpreting, by the computer system, the respective keyword by reference to at least one higher order keyword; and
(E) execute a search query to at least one data source using the interpreted search string.
